(19) United States
(12) Patent Application Publication
(10) Pub. No.: US 2012/0209556 A1
(43) Pub. Date: Aug. 16, 2012

(54) Low Power Scan-Based Testing

(75) Inventors: JANUSZ RAJSKI, West Linn, OR (US); Elham K. Moghaddam, Tigard, OR (US)

(73) Assignee: Mentor Graphics Corporation

(21) Appl. No.: 13/365,154

(22) Filed: Feb. 2, 2012

Related U.S. Application Data
(60) Provisional application No. 61/438,795, filed on Feb. 2, 2011.

(51) Int. Cl. G06F 19/00

(52) U.S. Cl. 702/108

(57) ABSTRACT

In a low power scan-based testing process, the loading of a test pattern may involve only a portion of the scan chains and the capturing of test response data for the test pattern may involve another portion of the scan chains. The two portions of the scan chains may be determined based on test patterns applied before and after the current test pattern. Clock gating circuitry may be used to select the two portions of the scan chains.

### RELATED APPLICATIONS

This application claims priority to U.S. Provisional Patent Application No. 61/438,795, entitled “Low Power Compression Utilizing Clock-Gating,” filed on Feb. 2, 2011, and naming Janusz Rajski et al. as inventors, which application is incorporated entirely herein by reference.

### FIELD OF THE INVENTION

The present invention is directed to integrated circuit testing technology. Various aspects of the invention may be particularly useful for low power scan-based testing.

### BACKGROUND OF THE INVENTION

As devices grow in gate count, data volume and application time for scan-based test grow significantly. Test compression techniques have been developed to reduce test data volume and test application time. A majority of the existing test compression techniques take advantage of low test cube fill rates to compress test patterns. In a paper authored by G. Mrugalski, et al., “Compression based on deterministic vector clustering of incompatible test cubes”, in Proc. IEEE. International Test Conference (ITC), November 2009 (referred to as Mrugalski et al. hereafter), which is incorporated herein by reference, a test data compression scheme is proposed to merge test cubes with a large number of identical specified bits despite the existence of a few conflicting specified bits. Each resulting test vector cluster comprises a parent pattern, a control pattern and a number of incremental patterns. In order to load scan chains with patterns that feature the original test cubes, a test controller combines the parent pattern with each of the incremental patterns separately based on the control pattern. While the compression ratio is increased due to the merging of incompatible test cubes, this scheme may limit the number of cores that can be tested in parallel due to high power consumption. The high power consumption is attributed to high switching activity in scan chains and other parts of the circuit-under-test. The excessive switching activity may cause overheating or supply voltage noise, either of which can in turn lead to device malfunction, increased chip reliability degradation, shortened circuit lifetime, or even a permanent circuit damage.

Various techniques have been proposed to reduce power consumption during a scan test. One group of the techniques is called X-filling. The X-filling techniques can be employed in a post-processing step in an ATPG (automated test pattern generation) flow and require no change to the ATPG procedures. Certain non-random values are assigned to unspecified positions of test cubes such that the number of state transitions of circuit nodes during shift or capture cycles is minimized. Similar concepts have been proposed for designs with test compression. However, these approaches only attempt to reduce the power consumption during the test pattern loading process. Power consumption during the test response unloading process and in the clock distribution network are not considered.

Another group of the techniques for reducing power consumption is based on disabling a number of the scan chains during certain time periods. These techniques divide test patterns in a given test set into different blocks and activate only a subset of scan chains at a given time. This may be achieved by enabling/disabling the clock control circuitry for each of the scan chains. Because not all of the scan chains are enabled, the power of the clock distribution and the combinational logic can both be reduced. However, these techniques may still result in high peak shifting power from time to time. When a new block of test data is shifted into the scan chains, most of the scan chains need be active at the same time. To resolve this problem, scan chains may be partitioned to selectively deactivate some scan chains in any test cycle. This, however, can lead to a significant increase in test time. Thus, challenges still remain to develop techniques that can reducing both switching activity in various test phases and test data volume without significantly increasing test time.

### BRIEF SUMMARY OF THE INVENTION

Aspects of the invention relate to low power scan-based testing. During testing a circuit, while first test response data for a first test pattern are being unloaded from a first group of scan chains, a portion of a second test pattern is loaded to the first group of scan chains. The first group of scan chains, a subset of scan chains in the circuit, comprises one or more conflicting scan chains for the first test pattern and the second test pattern and one or more observation scan chains for the first test pattern.

The loaded second test pattern is then applied to the circuit. Second test response data for the second test pattern is captured in a second group of scan chains. The second group of scan chains, also a subset of scan chains in the circuit, comprises one or more conflicting scan chains for the second test pattern and a third test pattern and one or more observation scan chains for the second test pattern.

While the second test response data for the second test pattern are being unloaded from the second group of scan chains, a portion of the third test pattern is loaded to the second group of scan chains.

The above process may be repeated until all available test patterns are applied to the circuit. It should be noted that if a test pattern needs to be loaded to all of the scan chains (e.g., the very first test pattern), the loading process may be performed in multiple steps to reduce switching activity.

To generate test patterns for low power scan-based testing, the test cube generation procedure may set two constraints for test cube merging: a maximum number for the number of conflicting scan chains for consecutive test patterns and a maximum number for the number of observation scan chains for each test pattern. In some embodiments of the invention, the former may be set to be greater than the latter. For a test employing test compression techniques, compression (encoding) feasibility may also be a constraint for test cube merging.

Low power scan-based testing methods may be implemented using test circuitry that comprises a control circuit. The control circuit supplies control signals to clock gating circuitry of the scan chains to control the loading/unloading and capturing operations. The control circuit may comprise a control register and an XOR network. The control circuit may further comprise a biasing circuit.

### BRIEF DESCRIPTION OF THE DRAWINGS

FIG. 1 illustrates four scan chains (A-D) in a circuit loaded with two incompatible test cubes (T₁ and T₂), respectively.

FIG. 2 illustrates an example of a loading/unloading process for five consecutive test cubes (T₁-T₅) and their test responses according to an embodiment of the invention.

FIG. 3 illustrates a flowchart 300 describing methods of low power testing according to various embodiments of the invention.

FIG. 4 an example of a low power testing system that can be used to perform low power testing methods illustrated by the flow chart 300 in FIG. 3.

### DETAILED DESCRIPTION OF THE INVENTION

Various aspects of the present invention relate to low power scan-based testing techniques. In the following description, numerous details are set forth for the purpose of explanation. However, one of ordinary skill in the art will realize that the invention may be practiced without the use of these specific details. In other instances, well-known features have not been described in detail to avoid obscuring the present invention.

Some of the techniques described herein can be implemented by a computer-readable medium having software instructions stored thereon, a programmable computer system executing software instructions, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms such as “apply,” “capture,” “load,” and “unload” to describe the disclosed methods. Such terms are high-level abstractions of the actual operations that are performed. The actual operations that correspond to these terms will vary depending on the particular implementation and are readily discernible by one of ordinary skill in the art.

Also, as used herein, the term “design” is intended to encompass data describing an entire integrated circuit device. This term also is intended to encompass a smaller group of data describing one or more components of an entire device, however, such as a portion of an integrated circuit device. Still further, the term “design” also is intended to encompass data describing more than one integrated circuit device, such as data to be used to form multiple integrated circuit devices on a single wafer.

### Test Cube Merging

Test cubes tend to be correlated. Faults that are structurally related require similar input bits for detection. Thus, many test cubes in a test set share identical values for many specified bits and differ in values for only a few specified bits. Here, the specified bits are bits in a test cube for which values must be specified for detecting one or more defects. Correspondingly, values for the rest of the bits do not affect the detection of the one or more defects and thus can be either “1” or “0.” These unspecified bits are often referred to as don't care bits.

Typically, ATPG tools or test data compression techniques apply test cube merging techniques to reduce pattern counts. In a test cube merging process, a test pattern is gradually developed by merging compatible test cubes with appropriate values assigned to unspecified bits. Two test cubes are compatible if for each specified bit in one test cube, the other test cube features either the same specified bit value or a don't care bit value. In another word, two test cubes are compatible if they do not have conflicting specified bits.

As observed in Mrugalski et al., by continuing the test cube merging process despite a few conflicting specified bits, a higher test compression ratio can be achieved. The method in Mrugalski et al. partitions test cubes into different clusters each containing one parent pattern that is compatible with all the other incremental test cubes in the cluster. For loading the test cubes of each cluster to the scan chains, it repeatedly applies the same parent pattern, every time using a different incremental test cube. As noted previously, however, this approach may increase switching activity.

Instead of shifting the parent pattern every time for all the test cubes in the cluster, scan chains including conflicting bits and observation bits may be updated for new test cube while the remaining scan chains hold current values. This can reduce both the amount of switching activity during the loading/unloading phase and the volume of test data needed to be delivered.

To facilitate the disclosure of various embodiments of the invention, three terms, compatible scan chains, conflicting scan chains and observation scan chains, are introduced here. A compatible scan chain for two test cubes corresponds to a portion of the two test cubes that do not have conflicting specified bits, while a conflicting scan chain corresponds to a portion of the two test cubes that have conflicting specified bits. An observation scan chain for a test cube is a scan chain in which one or more scan cells are used as an observation point for the test cube. An observation scan chain may be a compatible scan chain or a conflicting scan chain.

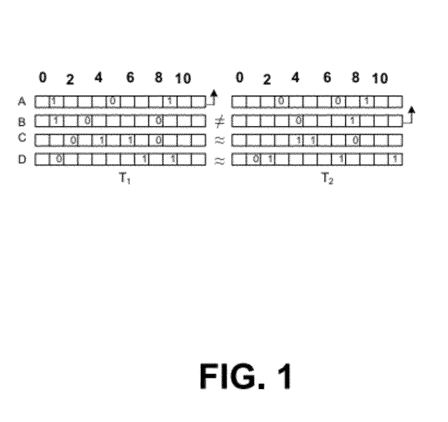

FIG. 1 illustrates four scan chains (A-D) in a circuit loaded with two incompatible test cubes (T₁ and T₂), respectively. Each of the four scan chains has 12 scan cells (A0-A11, B0-B11, C0-C11, and D0-D11). Only values for specified bits for each test cube are shown. As seen from the figure, scan chains A, C and D are compatible scan chains for T₁ and T₂ because no conflicting specified bits are loaded to them. Scan chain B, on the other hand, is a conflicting scan chain because scan cell B8 corresponds to the conflicting specified bit (“0” for T₁ vs. “1” for T₂). Also indicated by upward arrows in FIG. 1 are observation scan chains, A for T₁ and B for T₂.

To reduce switching activity and test data for delivery, portions of the test cubes T₁ and T₂ corresponding to the three compatible scan chains A, C and D could be merged. However, to observe any fault effect of T₁, the observation scan chain A should be used to capture test response data. The captured test response data need to be unloaded as well. Therefore, the observation scan chain A cannot hold the same values as it is loaded with. Accordingly, only portions of the test cubes T₁ and T₂ corresponding to the two compatible scan chains C and D should be merged to form a new test cube T₁*. During a test, the test cube T₁* is loaded to the scan chains first. After test response data for T₁*(T₁) are captured, they are unloaded while a portion of T₂*(T₂) corresponding to scan chains A and B is being loaded. This approach eliminates switching activity in scan chains C and D during this loading/unloading process.

### Low Power Scan Testing Methods

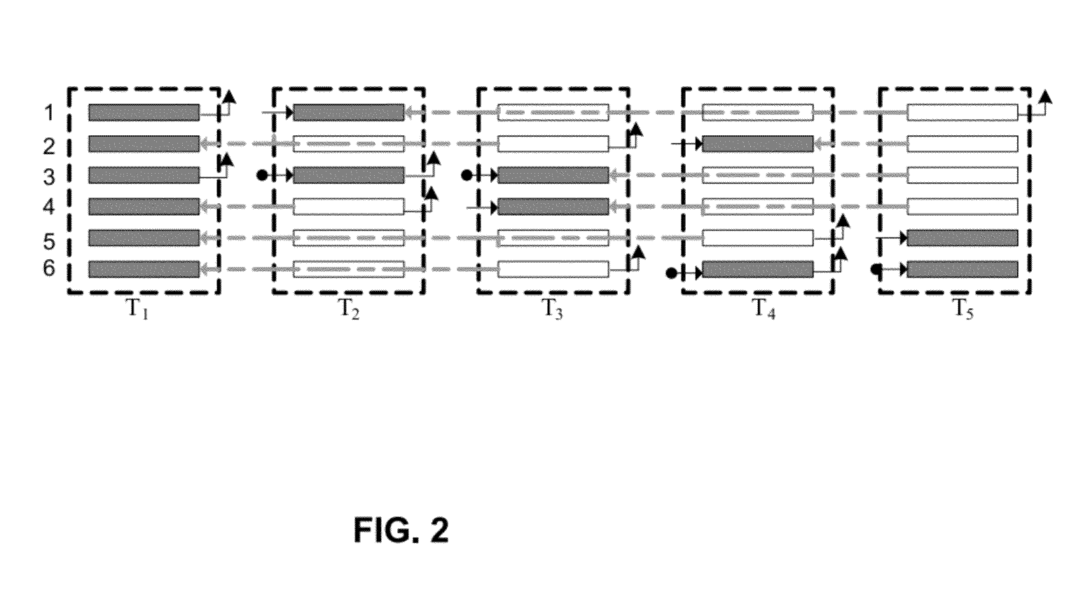

FIG. 2 illustrates an example of a loading/unloading process for five consecutive test cubes (T₁-T₅) and their test responses according to an embodiment of the invention. The five test cubes (T₁-T₅) may be generated using a test cube generation procedure based on two test cube merging constrains. The two test cube merging constrains limit the number of conflicting scan chains for two consecutive test cubes and the number of observation scan chains for each test cube within predetermined threshold values Δ and δ, respectively. Because the unloading of the test response to test cube Tᵢ₋₁ happens at the same time as the loading of test cube observation scan chains for test cube Tᵢ₋₁ may be used for the loading of test cube Tᵢ, i.e., serving as conflicting scan chains for the test cubes Tᵢ₋₁ and Tᵢ. This can provide more freedom for generating the next test cube Tᵢ based on the current test cube Tᵢ₋₁. Accordingly, with some implementations of the invention, the threshold value δ may be set to be less than the threshold value Δ. In the example shown in FIG. 2, Δ and δ are set to be 2 and 1, respectively. In some embodiments of the invention that employs test compression techniques, the test cube generation procedure may be pseudo-coded as follows:

for (every fault in fault list)

Generate a test cube and Put test cube in buffer.

end for
Set C_{load} and C_{unload} to be the list of scan chains need to be loaded and
unloaded for each test vector.
Set P to be an all-X pattern
while (C_{unload}< δ)

Select one test cube from buffer and merge with P.
Add observation scan chains to C_{unload}

end while
Add P to test set T.
while (buffer is not empty)
C_{load} = C_{unload} , C_{unload} = ø
Set P to be an all-X pattern
while(C_{unload}< δ and C_{load} < Δ )
Sort test cube in buffer based on the highest degree of similarity with
previous test cube.
Pick first compatible test cube with P from buffer.
if (no compatible test cube in buffer)

exit while loop

Add new load and unload chains to C_{load} and C_{unload}.
Compress the specified bits on C_{load}.
Move the specified bits of remaining chains to the test vector in which
the scan chains are reloaded.
Try to compress new combined test cube.
if (compression fails)

exit while loop

end while
If (C_{load} < Δ)
Randomly select (Δ − C_{load}) unselected chains and add to C_{load}.
for (each test vector P of set T)
if (all the scan chains have been loaded at least one in the successor test
vector P) {
decompress compress test vector P
perform fault simulation
}
end for
end while

In the above procedure, the test cube T₁ is initially generated by merging all compatible test cubes in the buffer such that both the number of observation scan chains (C_{unload}) does not exceed the given threshold δ and compression does not fail.

The next test cube T₂ is generated based on the test cube T₁. In this step, C_{unload} of the test cube T₁ should be loaded with new values during shifting test vector T₂ into scan chains as C_{load} of T₂ (conflicting scan chains for T₁ and T₂) is set to include the scan chains in C_{unload} of T₁. For every remaining test cube in the buffer (candidate test cubes), the number of specified bits that each candidate test cube has in common with test vector T₁ is determined. It should be noted that the values of scan chains that are not included in C_{load} are compared with test cubes in buffer. Also determined is whether the number of conflicting scan chains for each test cube with T₁ is greater than Δ. If it is, that candidate test cube will be deleted from the list of candidate test cubes that could be merged with T₂.

After all the candidate test cubes are scanned, the one with the highest degree of similarity with T₁ (the largest number of common specified bits) is selected as a base test cube for T₂. T₂ is then generated by merging the base test cube with compatible candidate test cubes under the constraints imposed by factors δ and Δ and by compression feasibility. If the total number of scan chains that should be loaded for T₂ (C_{load}) is less than Δ, (Δ−C_{load}) scan chains may be randomly selected and placed in C_{load}. Those scan chains that have not been loaded with a new value for a long time may be selected. As for compression of the test cube T₂, only the specified bits that are included in C_{load} need to be encoded and the specified bits in the remaining scan chains are merged to the test cube T₁.

After the test cube T₂ is generated, the generation of the next test cube T₃ starts. Scan chains in C_{unload} of T₂ are placed in C_{load} of T₃. Then the same procedure as mentioned above except the compression part is executed. As for compression of the test cube T₃, only the specified positions are included in C_{load} are encoded while the remaining specified bits are moved to the nearest test vector in which the scan chains are reloaded with the new value. In FIG. 2, for example, all specified bits in the scan chain 1 of T₃ are moved to the test cube T₂ in which scan chains 1 is loaded with new values. All the specified bits in the remaining scan chains 2, 5 and 6 are moved to test cube T₁ in which they are loaded with new values. In FIG. 2, the scan chains whose specified bits are merged to the previous vectors are shown with dashed backward arrows, and conflicting scan chains for each pair of test cubes Tᵢ₋₁ and Tᵢ are indicated with upward arrows.

By the time the test cube T₅ is generated in the example illustrated in FIG. 2, all the scan chains are reloaded at least once. Therefore, none of specified bits of subsequent test cubes can be moved to T₁. Accordingly, all unspecified bits in the scan chains included in C_{load} of T₁ can now be filled with random values and fault simulation can be performed on T₁. New test cubes may then be generated following the same procedure until no candidate test cubes remain in the buffer.

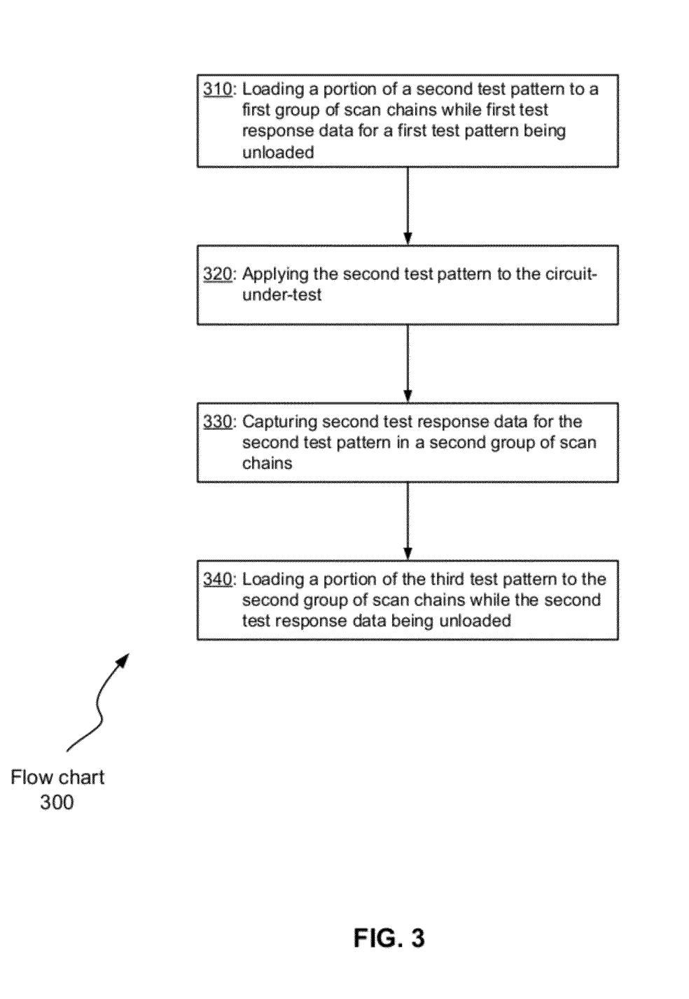

With the generated test cubes, a low power testing process may be performed according to a flow chart 300 illustrated in FIG. 3 according to various embodiments of the invention. In operation 310, a portion of a second test pattern (test cube Tᵢ) is loaded to a first group of scan chains while the test response data for a first test pattern (test cube Tᵢ₋₁) are being unloaded. This operation corresponds to any loading/unloading process shown in FIG. 2. The process of unloading test response data for T₂ and loading T₃ is one of them: specified bits of T₃ that conflict with T₂ are loaded to scan chains 3 and 4, and test response data for T₂ captured is unloaded simultaneously. It should be noted that if the first test pattern (test cube Tᵢ₋₁) requires all scan chains to be loaded (similar to T₁ in FIG. 2), the loading process may be performed in multiple steps to reduce switching activity.

In operation 320, the loaded second test pattern (test cube Tᵢ) is applied to the circuit. Next, in operation 330, the test response data for Tᵢ are captured in a second group of scan chains. One or more scan chains (including all scan chains) in the second group of scan chains may be used in the capturing operation. In FIG. 2, the second group of scan chains corresponding to the above example (the process of unloading test response data for T₂ and loading T₃) includes scan chains 2 and 6.

In operation 340, a portion of a third test pattern (test cube Tᵢ₊₁) is loaded to the second group of scan chains while the captured test response data for Tᵢ are being unloaded. Using the same example in FIG. 2, this corresponds to the loading for T₄ and the unloading for T₃ through scan chains 2 and 6. The operations 310-340 may be repeated until all the test cubes are applied to the circuit.

### Low Power Testing System

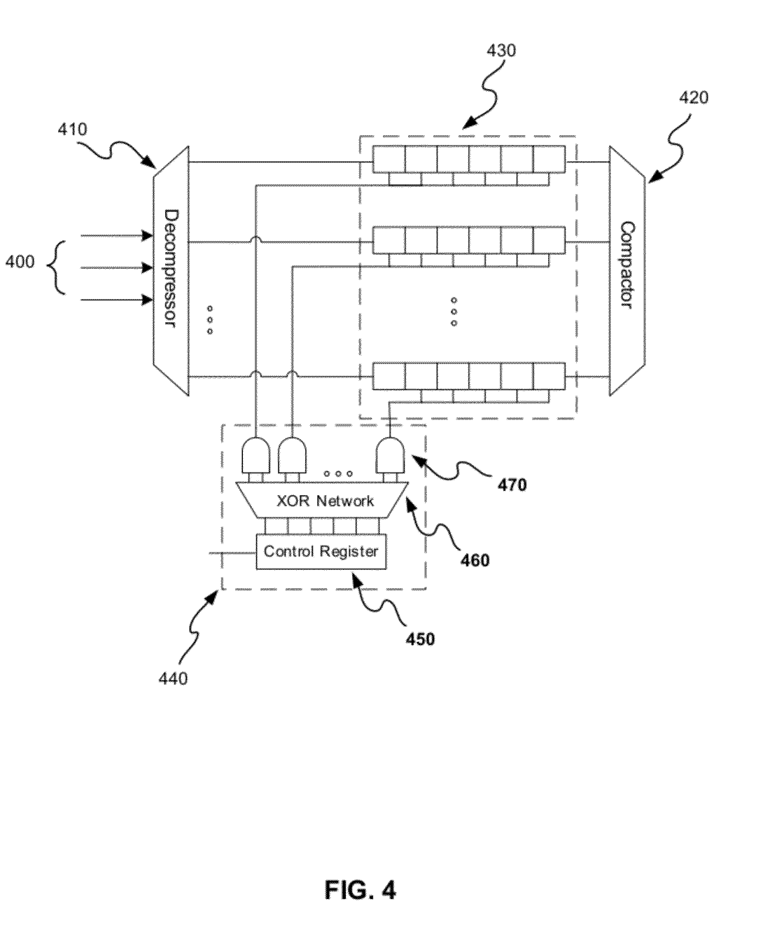

FIG. 4 illustrates an example of a low power testing system that can be used to perform low power testing methods illustrated by the flow chart 300 in FIG. 3. It should be appreciated, however, that low power testing methods illustrated by the flow chart 300 can be performed by different low power testing systems according to various embodiments of the invention. Likewise, the low power testing system shown in FIG. 4 may be used to perform low power testing methods according to various embodiments of the invention that are different from those illustrated by the flow chart 300.

The low power testing system in FIG. 4 includes a decompressor 410, a compactor 420, scan chains 430 and a control block 440. The decompressor 410 is configured to generate test patterns based on encoded test data (compressed test patterns) and to load the test patterns to the scan chains 430. The encoded test data are supplied to the decompressor 410 through input channels 400. The compactor 420 is configured to compress test response data unloaded from the scan chains 430. The control block 440 includes a control register 450, a combinational XOR network 460, and a biasing circuit 470. The control block 440 provide control signals such as clock gating signals based on control data stored in the control register 450. The control signals control the clock signal of each scan chain: when a control signal for a scan chain is 0, this scan chain does not receive any clock transitions either in the shift mode or in the capture mode. As a result, no clock power is dissipated for this scan chain. When a control signal for a scan chain is 1, this scan chain is being driven directly by the decompressor 410.

The fraction of scan chains driven directly by the decompressor 410 is determined by the biasing circuit 470. In FIG. 4, the biasing circuit 410 includes a group of AND gates driven by the XOR network 460. When 2-input AND gates as shown in FIG. 4 are used, approximately 25% of scan chains are driven by the decompressor 410 while the remaining ones retain their values. This percentage can be reduced by adding more inputs to the AND gates. For example, 3-input AND gates can reduce the percentage of scan chains driven by the decompressor 410 down to 12.5%, while the fraction of scan chains holding their states increases accordingly. The procedure used for encoding the control data stored in the control register may be similar to the procedure used in the paper authored by D. Czysz, M. Kassab, X. Lin, G. Mrugalski, J. Rajski, J. Tyszer, “Low power scan shift and capture in the EDT environment”, Proc. IEEE International Test Conference (ITC), paper 13.2, 2008, which is incorporated herein by reference.

The number of scan chains that can be driven by the decompressor 410 may depend on the encoding capabilities of the XOR network 460. Because the encoding process is equivalent to solving a set of linear equations, setting a gating signal to a pre-specified value requires one or two equations. For instance, allowing the decompressor 410 to drive a given scan chain requires solving two equations xᵢ=1 (one for each input of the AND gate). For scan chains that need to hold their value, one equation xᵢ=0 is enough to set the output of AND gate to 0 (any input of AND gate can be chosen to set to 0).

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method for low power testing, comprising:
loading a portion of a second test pattern to a first group of scan chains while first test response data for a first test pattern being unloaded from the first group of scan chains, the first group of scan chains being a first subset of scan chains in a circuit, the first group of scan chains comprising one or more conflicting scan chains for the first test pattern and the second test pattern and one or more observation scan chains for the first test pattern;
applying the second test pattern stored in the scan chains to the circuit;
capturing second test response data for the second test pattern in a second group of scan chains, the second group of scan chains being a second subset of the scan chains in the circuit, the second group of scan chains comprising one or more conflicting scan chains for the second test pattern and a third test pattern and one or more observation scan chains for the second test pattern; and
loading a portion of the third test pattern to the second group of scan chains while the second test response data being unloaded from the second group of scan chains.

2. The method recited in claim 1, further comprising:
loading the first test pattern to the scan chains in multiple steps.

3. The method recited in claim 1, further comprising:
loading a fourth test pattern to the scan chains in multiple steps.

4. The method recited in claim 1, wherein the portion of the second test pattern and the portion of the third test pattern are outputted from a decompressor.

5. The method recited in claim 4, wherein the unloaded first test response data and the unloaded second test response data are processed by a compactor.

6. The method recited in claim 1, wherein the first group of scan chains and the second group of scan chains are selected by clock-gating circuitry based on a first control signal and a second control signal, respectively.

7. The method recited in claim 6, wherein the first control signal and the second control signal are generated by a control circuit.

8. The method recited in claim 7, wherein the control circuit comprises a control register and an XOR network.

9. The method recited in claim 1, wherein the first test pattern, the second test pattern and the third test pattern are generated based on a test cube generation procedure, the test cube generation procedure merging test cubes under at least two constraints one of which limits a number of conflicting scan chains for consecutive test patterns to a first predetermined value and the other one of which limits a number of observation scan chains for each test pattern to a second predetermined value.

10. The method recited in claim 9, wherein the first predetermined value is greater than the second predetermined value.

11. The method recited in claim 1, wherein the one or more conflicting scan chains for the first test pattern and the second test pattern comprises the one or more observation scan chains for the first test pattern.

12. The method recited in claim 1, wherein the one or more conflicting scan chains for the second test pattern and the third test pattern comprises the one or more observation scan chains for the second test pattern.

13. The method recited in claim 1, wherein the second test response data for the second test pattern is captured in one or more scan chains in the second group of scan chains.

14. A system, comprising a circuit under test, scan chains and a control circuit, the control circuit supplying control signals to clock gating circuitry of the scan chains to enable the system to perform a method for low power testing, the method comprising:
loading a portion of a second test pattern to a first group of scan chains while first test response data for a first test pattern being unloaded from the first group of scan chains, the first group of scan chains being a first subset of the scan chains, the first group of scan chains comprising one or more conflicting scan chains for the first test pattern and the second test pattern and one or more observation scan chains for the first test pattern;
applying the second test pattern stored in the scan chains to the circuit under test;
capturing second test response data for the second test pattern in a second group of scan chains, the second group of scan chains being a second subset of the scan chains in the circuit, the second group of scan chains comprising one or more conflicting scan chains for the second test pattern and a third test pattern and one or more observation scan chains for the second test pattern; and
loading a portion of the third test pattern to the second group of scan chains while the second test response data being unloaded from the second group of scan chains.

15. The system recited in claim 14, further comprising:
a decompressor configured to generate test patterns based on encoded test data and to load the test patterns to the scan chains; and
a compactor configured to compress test response data unloaded from the scan chains.

16. The system recited in claim 14, wherein the control circuit comprises a control register and an XOR network.

17. The system recited in claim 16, wherein the control circuit further comprises a biasing circuit.
